(19) United States
(12) Patent Application Publication
(10) Pub. No.: US 2010/0318404 A1
(43) Pub. Date: Dec. 16, 2010

(54) COMPENSATING STORES FOR CONSUMER INFLUENCE WITH AUTOMATED TRACKING

(75) Inventors: Kamal Jain, Bellevue, WA (US); Yuval Peres, Redmond, WA (US); Nikhil Rangarajan, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/484,279

(22) Filed: Jun. 15, 2009

(51) Int. Cl. G06Q 30/00; G06Q 10/00; G06Q 50/00

(52) U.S. Cl. 705/10; 705/11; 705/26; 705/34

(57) ABSTRACT

Consumer stores typically sell products at a retail profit, which covers the cost of pre-sale, consumer-influencing services regarding the products (e.g., discussions with sales associates, product demonstrations, and consumer inspections of the products.) However, consumers may utilize these services but may purchase selected products from other retailers that do not provide pre-sale services, and that may accordingly offer lower prices. This tactic may cause lost sales for consumer stores, and eventually store failures. Instead, the consumer store may charge the supplier an influence fee for consumer-influencing services based on a per-service price established between the supplier and the consumer store and consumer influence metrics tracked by a computer. The supplier may recoup the influence fee in the wholesale cost of the product, thereby distributing the shared benefit of the influencing services of the consumer store across all retailers and enabling a sustainable business model for providing the consumer-influencing services.

### BACKGROUND

Many consumer stores serve consumers not only by providing a set of products for sale, but also by providing product-related services, such as informed recommendations by sales associates, customer service, and technical support. These services entail expenditures by the business, such as sales employee salaries and training, customer service, and technical support. The business usually recoups these expenditures from profits achieved from the sale of products.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In the “brick-and-mortar” business model, the consumer store profits from the sale of products, and uses such profits to provide pre-sale and post-sale services provided to consumers. However, e-commerce stores often provide a lower level of customer service, but may sell products at a lower price, thereby outcompeting the brick-and-mortar stores. Consumers often benefit from both business models by conducting pre-purchase research at a brick-and-mortar store to select a product, and then ordering that product at a lower price from an e-commerce store. This business reality may render such consumer stores unsustainable, and the closing of such businesses adversely affects both consumers, who may no longer receive free access to such product services, and suppliers, who may no longer rely on the venue of the consumer store to persuade consumers to purchase such products.

Instead, a consumer store (particularly a “brick-and-mortar” business) may endeavor to recover the costs of product-related services from the suppliers of such products. In particular, the consumer store may offer to stock a product of suppliers only if the suppliers agree to pay the consumer store for providing product-related services, particularly if the provision of such services influences consumers to purchase the product. For example, a consumer store may hire employees who are knowledgeable about a particular class of products and can provide valuable information to consumers, such as comparisons, recommendations, and product demonstrations. This arrangement may promote a sustainable consumer store; may benefit consumers, who may continue receiving free product-related services from the consumer store; and may permit suppliers to allocate the cost of such product-related services evenly to all retailers, e.g., by factoring the aggregate cost of such services into the wholesale price of the product offered to all suppliers.

However, it may be difficult to quantify the value of such services to particular suppliers as justification for compelling participation and payment. In particular, a supplier may not trust the claimed value of the influence asserted by the consumer store, particularly if the claimed value is based on an aggregated estimate of the consumer store without backing metrics. Therefore, techniques may be developed to correlate the fees charged to various suppliers to the consumer influence achieved by the consumer store, and to establish tightly correlated prices for such services. One such technique involves establishing with the supplier a per-service price for particular services that influence consumers, and then, using a computer, tracking instances of providing the service for a consumer regarding a product and charging the supplier an “influence fee” based on the provided services (factoring in the established per-service price.) By tracking and charging suppliers for the provision of such services in a demonstrable manner, these techniques may permit a consumer store to provide product-based services to consumers in a sustainable manner, while also pricing products competitively with both e-commerce stores and other brick-and-mortar businesses.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of consumer decisions in purchasing a product of a supplier.

FIG. 2 is another illustration of consumer decisions in purchasing a product of a supplier.

FIG. 3 is an illustration of an interaction between a supplier and a consumer store involving a per-service influence fee.

FIG. 4 is a flow chart illustrating an exemplary method of compensating a consumer store for consumer influencing services provided to consumers regarding at least one product of a supplier.

FIG. 5 is a component block diagram illustrating an exemplary system for compensating a consumer store for consumer influencing services provided to consumers regarding at least one product of a supplier.

FIG. 6 is an illustration of an exemplary computer-readable medium comprising processor-executable instructions configured to embody one or more of the provisions set forth herein.

FIG. 7 is an illustration of various techniques for tracking consumer influencing services provided to a consumer by a consumer store regarding a product.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Many consumer stores serve not only as a source of offered products that may be purchased, but as a source of product-related services. Such services include both pre-sale services, such as advertising, recommendations, hands-on examination, product demonstrations and information, and post-sale services, such as accepting returns, providing warranty support, and providing installation and troubleshooting. The supplying of these services consumes resources of the business, such as sales employee salaries and training, infrastructure costs of customer service and technical support, shipping, and the stocking of parts. However, the business usually recoups these expenditures from profits realized from the sale of products, including (in a simplified view) the difference between the wholesale cost of the product and the retail price.

However, the advent of e-commerce businesses has impaired the viability of this business model. E-commerce stores often provide fewer services, such as a venue for physically browsing products in a product category or conducting a hands-on examination of a product; a restricted level of customer service; and little or no technical support. However, these e-commerce stores pass this cost savings to consumers by reducing the retail markup on products, thereby offering lower prices on the same products available at brick-and-mortar stores. Consumers may therefore prefer to buy at lower prices from online stores; however, these consumers still wish to receive pre-sale services, such as hands-on examination of the product before purchasing.

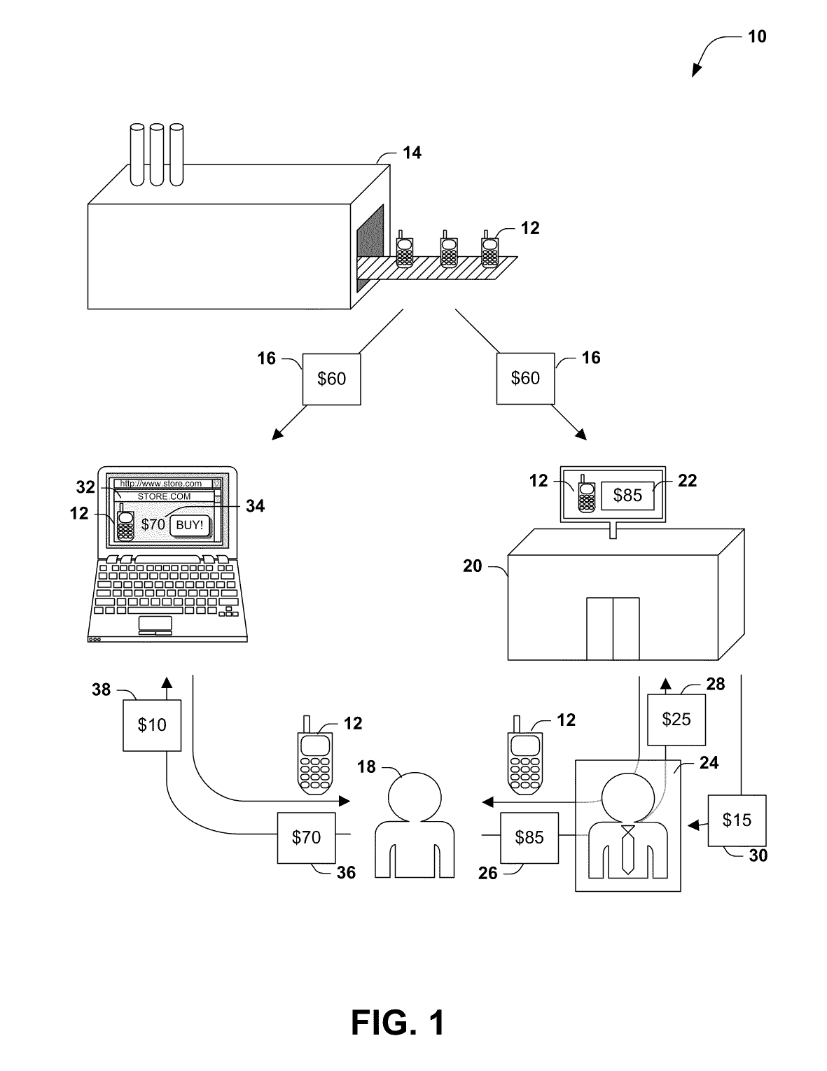

Therefore, consumers often visit a brick-and-mortar store for pre-sale support (such as browsing available goods, asking questions, and obtaining product demonstrations) and to select a product, but then order the product at the lower price from the e-commerce store. FIG. 1 illustrates an exemplary scenario 10 depicting the actions and choices of a consumer 18 in purchasing a product 12, such as a cellphone, produced by a supplier 14. The supplier 14 may sell the product 12 at a wholesale price 16 (e.g., $60) to various retailers, including a consumer store 20 and an e-commerce store 32. The consumer store 20 may offer the product 12 at a retail price 22 (e.g., $85.) The consumer 18 may visit the consumer store 20 in order to discuss the product 12 with an employee 24, to examine the product 12 firsthand, and to compare the product 12 to other products in the same product category (e.g., other models offered by the supplier 14 and by other suppliers.) The consumer 18 may then choose the product 12 among the available products in the product category. If the consumer 18 purchases the product 12 at the consumer store 20, the consumer 18 may submit a retail payment 26 of $85 in exchange for the product 12; the consumer store 20 may receive a retail profit 28 of $25, out of which may be paid an employee salary 30 of $15, leaving a net retail profit of $10. However, after selecting the product 12, the consumer 18 may choose not to purchase the product 12 at the consumer store 20, but may look for the product 12 at a better price elsewhere. For example, the consumer 18 may search the internet, and may discover that the product 12 is available from the e-commerce store 32. Because the e-commerce store 32 does not have to cover the cost of a sales associate 24, the e-commerce store 32 may be able to offer the product 12 at a discounted retail price 34 of $70. The consumer 18 may submit a discounted retail payment 36 of $70, leaving $10 in net retail profit for the e-commerce store 32.

As a result of the choices of the consumer 18, the consumer 18 has benefited both by obtaining pre-sale services from the consumer store 20 (e.g., the assistance of a sales associate 24 and the hands-on examination of the product 12), and by obtaining the product 12 at the discounted retail price 34 offered by the e-commerce store 32. The consumer 18 has thus obtained the benefit of the services provided by the consumer store 20 but has avoided paying for the services. Similarly, the e-commerce store 32 has benefited by allowing the consumer 18 to purchase the product 12 after being persuaded of the value of the purchase resulting from the services of the consumer store 20, but has also not paid for the services offered by the consumer store 20. The supplier 14 also benefits from this arrangement, because the consumer 18 has been persuaded by the services of the consumer store 20 to purchase the product 12 from the supplier 14 instead of from another supplier or simply foregoing the purchase; yet, the supplier 14 has also not paid for the services provided by the consumer store 20. However, the consumer store 20 is disadvantaged, because it has provided the services, such as the knowledge of the sales associate 24 and the inspection of stocked products, without obtaining the sale, and therefore cannot cover the costs of providing the services.

If the consumer store 20 continues to sustain losses through the arrangement depicted in FIG. 1, the consumer store 20 may lose a significant number of sales. The consumer store 20 may have to cut costs by reducing the provision and quality of such services (e.g., by hiring sales associates 24 at employee salaries 30 but who have less knowledge of the products 12 and by reducing the business hours of the consumer store 20), and/or may have to raise costs, such as by raising the retail prices 22 of products 12. However, service cutbacks reduce the service advantage of the consumer store 20 over the e-commerce store 32, and raising retail prices 22 exacerbates the price difference with the e-commerce store 32, causing the consumer store 20 to lose even more sales.

This negative feedback loop may cause steadily diminishing profits for the consumer store 20, and may eventually cause a market failure and store closure. In contrast with the advantages to the consumer 18, the e-commerce store 32, and the supplier 14 indicated in FIG. 1, the closing of the consumer store 20 may disadvantage the other parties. The consumer 18 may no longer access the sales associate 24, inspect products 12 firsthand, or access in-store services, such as returns. The e-commerce store 32 may experience reduced sales from consumers 18 who are not persuaded to buy the product 12, as well as an increased rate of returns of products 12 that the consumer 18 was unable to inspect before purchasing. The supplier 14 may also experience diminished sales if consumers 18 are unable to examine the product 12 before sale to identify advantages over a currently owned product, or of the higher quality of the product 12 as compared with similar products by other suppliers. Therefore, the loss of the consumer store 20 and the services provided thereby reduces sales of the product 12 due to the circumvention of a payment mechanism to cover the value of the services provided. This exemplary scenario 10 therefore exhibits a classic economic phenomenon known as the “dilemma of the commons,” wherein a shared public utility is consumed without recompense to exhaustion, leading to a shared disadvantage.

It may be appreciated that the consumer store 20 is likely unable to recoup the value of the services by charging more for the product 12, because these costs do not impact other retailers, such as the e-commerce store 32. However, it may be feasible to distribute these costs by charging the value of the service back to the supplier 14. In particular, the consumer store 20 may be able to charge the supplier 14 for the incremental value of the services provided—i.e., the influence that the consumer store 20 has had on the consumer 18 in deciding to purchase the product 12. The supplier 14 might cover the costs of the service paid to the consumer store 20 by raising the wholesale price 16 of the product 12.

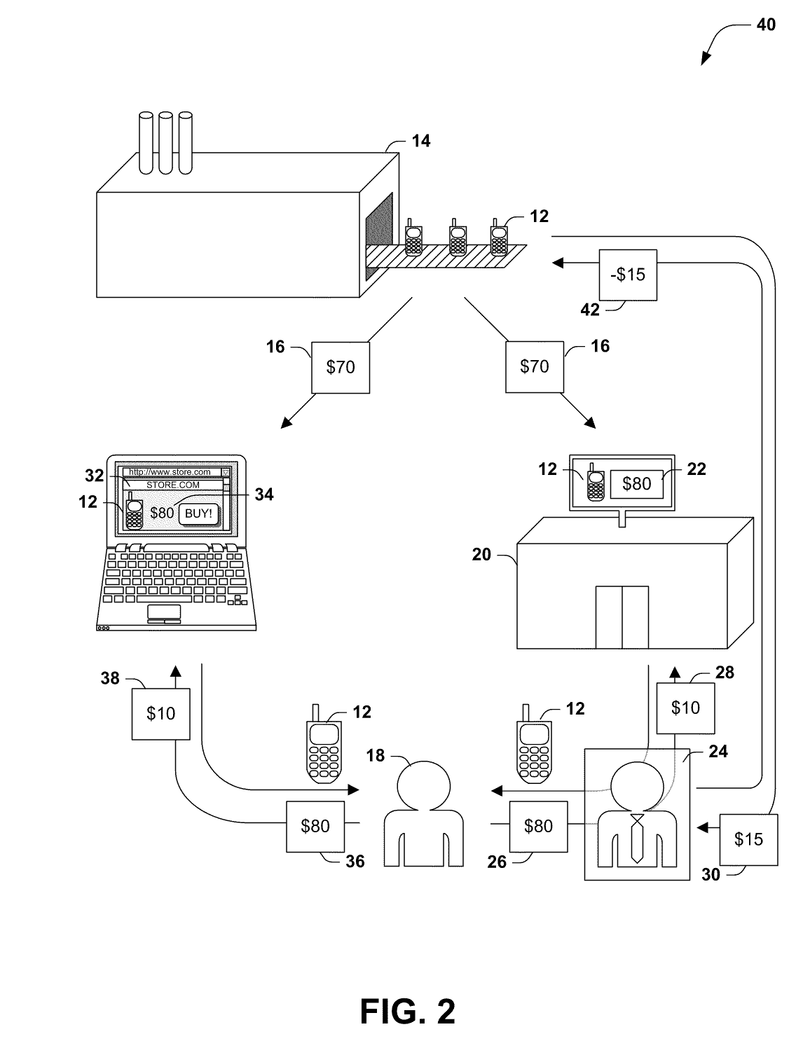

FIG. 2 illustrates an exemplary scenario 40 whereby the costs of the services provided by a consumer store 20 are covered by an influence fee charged to the supplier 14. The supplier 14 again provides a product 12 to both the consumer store 20 and the e-commerce store 32. However, in contrast with the exemplary scenario 10 of FIG. 1, the consumer store 20 determines the influence of the services provided to the consumer 18 (e.g., the interaction with a sales associate 24, as well as other services [not depicted] such as the ability to inspect the product 12 before purchasing) and charges an influence fee 42 to the supplier 14 (e.g., $15.) The consumer store 20 receives the influence fee 42 from the supplier 14 and recoups the costs of the services, such as the employee salary 30 provided to the sales associate 24. This influence fee 42 may represent the value to the supplier 14 in having the services of the consumer store 20 sell the product 12 to the consumer 18. It is noteworthy that the influencing of the consumer 18 is thereby achieved regardless of where the consumer 18 chooses to purchase the product 12.

This scenario changes the dynamics of the exemplary scenario 40 in ways that provides advantages to all parties. The consumer 18 continues to benefit from the freely provided services of the consumer store 20. The supplier 14 achieves the benefit of selling one unit of the product 12 to the consumer 18, regardless of the retailer chosen by the consumer 18, because the consumer 18 may be able to recognize the advantages of the product 12 over competing products by other suppliers, or over an older model currently used by the consumer 18. Moreover, the supplier may distribute the cost more evenly over all retailers by raising the wholesale price 16 of the product 12 (e.g., to $70.) (It may be appreciated that the influence fee 42 only arises from a subset of the units of the product 12 sold, i.e., to the incremental number of additional units sold due to the persuasion of the consumer 18 by the services of the consumer store 20. Therefore, the influence fee 42 does not directly correlate to a dollar-for-dollar increase in the wholesale price 16, but is distributed across all units of the product 12, including units sold to consumers 18 who did not utilize the persuasive services of the consumer store 20.) The consumer store 20, having already covered the expenses of the product-related services (e.g., the employee salary 30 of the sales associate 24), may lower the retail price 22 of the product 12 (e.g., to $80.) While the e-commerce store 32 has to raise its discounted retail price 36 to $80 to retain the same net profit on a sale of the product 12, this higher retail price accounts for the persuasion of the consumer 18 to purchase the product 12 from the e-commerce store 32 based on the services provided by the consumer store 20, and permits the ongoing provision of such services in a sustainable business model. The consumer store 20 and the e-commerce store 32 may therefore compete for sales on a more traditional basis (e.g., by price wars and reduced profits) without particularly encumbering the consumer store 20 with the total costs of the shared public service.

However, a key problem in the provision of the influencing services to the supplier 14 is the difficulty in measuring the influence. The total sales of the product 12 at the consumer store 20 may not be a good metric of influence, because the consumer 18 may choose to purchase the product 12 at another retailer; alternatively, the consumer 18 might have purchased the product 12 at the consumer store 20 without engaging any of the product-related influencing services, e.g., without inspecting the product 12 or interacting with a sales associate 24. Moreover, the supplier 14 might not trust aggregate, speculative, or qualitative indicators of such influencing, because the consumer store 20 might be able to inflate such indicators in order to cover its costs or achieve more profit.

Therefore, the charging of influence fees 16 may only be feasible if more reliable, quantitative metrics of influence may be identified. One such technique involves using a computer to track the provision of consumer influencing services, such as interactions of sales associates 24 and consumers 18 regarding a product 12, a pre-sale interest expressed by the consumer 18 in the product 12, and pre-sale demonstrations of the product 12 for the consumer 18. Additional consumer influencing services may also be provided and tracked; e.g., the consumer 12 might be offered an opportunity for post-sale service of the product 12 by the consumer store 20 after speaking with a sales associate 24, even if the consumer 18 does not purchase the product 12 from the consumer store 20. If the consumer 18 later utilizes this offer for a purchased unit of the product 12, this utilization may be indicative of a consumer influence by the consumer store 20 in purchasing the product 12, even if the consumer 18 chose to purchase the product 12 at another retailer. Thus, the influencing can be tracked by a computer and may be charged to the supplier 14 as a reliable, quantitative metric of a consumer influencing service.

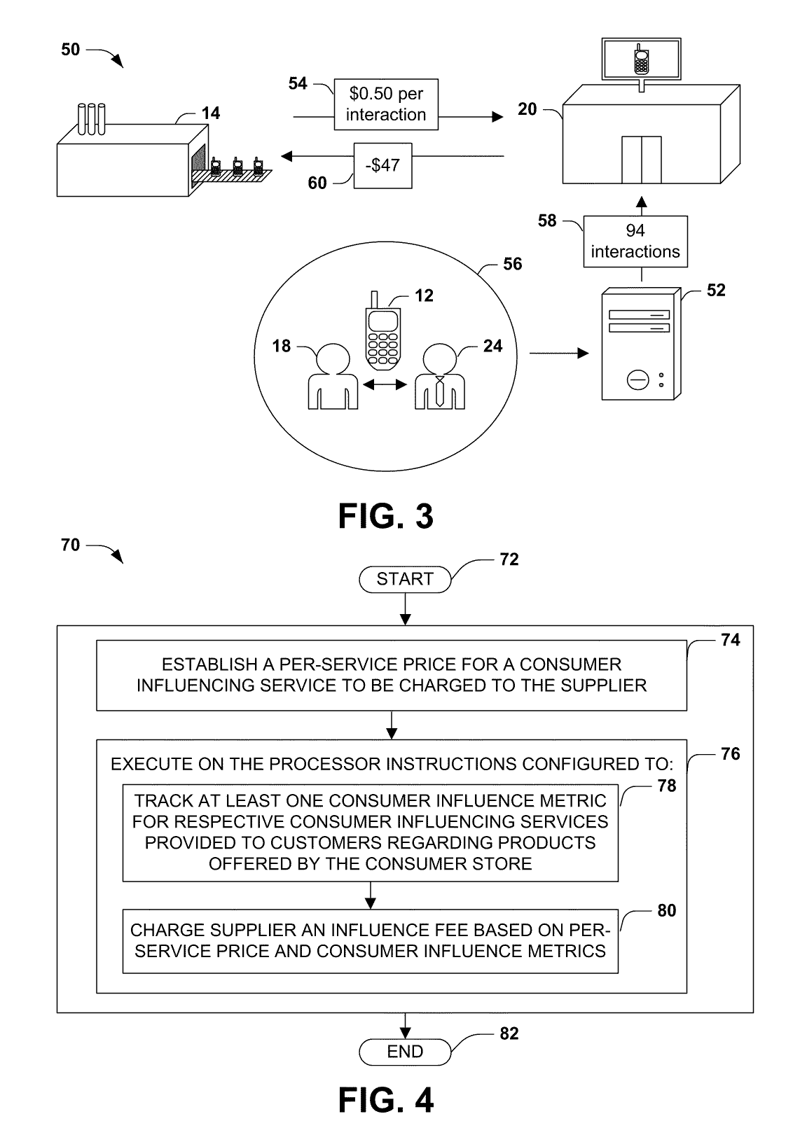

FIG. 3 illustrates an exemplary scenario 50 involving a computer 52 configured to track influencing services provided by a consumer store 20 to consumers 18 regarding a product 12 of a supplier 14. In this exemplary scenario 50, the supplier 14 and the consumer store 20 may establish a per-service price 54 for various influencing services offered by the consumer store 20, which is to be paid by the supplier 14 to the consumer store 20 upon receiving a report of the provided influencing services. The consumer store 20 may therefore configure and equip a computer 52 to track the provision of such influencing services, and to charge the supplier 14 accordingly. For example, the supplier 14 and the consumer store 20 may establish a per-service price 54 of $0.50 for each interaction of a sales associate 24 with a consumer 18 regarding the product 12 of the supplier 14 (e.g., product demonstrations, comparative recommendations, or the provision of feature information.) Upon detecting such an interaction 56 between a sales associate 24 and a consumer 18, the computer 52 may track the interaction 56, e.g., as a consumer influence metric 58 representing the interaction 56. The consumer influence metric 58 may be recorded, e.g., as a record in a log or database, and/or may be reported to a tracking server, such as via a web service. The computer 52 may then compute an influence fee 60 based on the per-service price 54 and the consumer influence metrics 58, and may charge the influence fee 60 to the supplier 14. Through this technique, the manufacturer 14 and the consumer store 20 may establish a more factual basis for accruing and assessing charges for the influencing services of the consumer store 20. Moreover, the manufacturer 14 and the consumer store 20 may negotiate different per-service prices 54 for different influencing services, based on the perceived or determined influencing significance of the service on the purchasing decisions of the consumer 18.

FIG. 3 also illustrates an additional advantage of these techniques. As a result of these techniques, both the consumer store 20 and the supplier 14 have a significantly greater interest in providing good products 12 and promoting consumers' experiences. Consumers 18 who find the product-related influencing services (e.g., information, recommendations, and demonstrations) of the consumer store 20 to be worthwhile will return for additional services regarding additional products 12. This consumer value will strongly correlate with a demonstrably higher influence of the provided services, and the consumer store 20 may establish higher per-service prices 54 and consequently charge higher influence fees 60 (in addition to providing more influencing services for a growing and returning population of consumers 18.) Conversely, if consumers 18 have poor experiences with the services of the consumer store 20 or are not satisfied with recommended products 12, the consumers 18 will be less inclined to return, reducing influential value of the services provided by the consumer store 20, and also reducing both the per-service price 54 that suppliers 14 may be willing to pay and the demand for such consumer influencing services by consumer 18. Similarly, suppliers 14 also have an incentive to provide high-quality products 12, which may achieve higher sales of such products 12 (both through the consumer store 20 and other retailers) due to the positive, trusted, and influential services provided by the consumer store 20 for such products 12, while low-quality products 12 will be quickly removed from the consumer store 20 due to the negative experiences reported by consumers 18 and diminishing services (such as recommendations) that the consumer store 20 may provide to such products 12. Therefore, these techniques induce a shift of focus by the consumer store 20 from achieving high per-unit sales of all products 12 to establishing a well-founded and valuable influencing relationship with consumers 18; and suppliers 14 may achieve amplified sales of good products 12 and greater market penalties for poor products 12.

FIG. 4 illustrates an exemplary embodiment of the techniques discussed herein, comprising an exemplary method 70, using a computer 52 having a processor, of compensating a consumer store 20 for influencing consumer choices regarding products 12 offered by at least one supplier 14. The exemplary method 70 begins at 72 and involves establishing 76 a per-service price 54 for a consumer influencing service to be charged to the supplier 14. The exemplary method 70 also involves executing 74 on the processor instructions that are configured to track 78 at least one consumer influence metric 58 for respective consumer influencing services provided to at least one consumer 18 and regarding at least one product 12 offered by the consumer store 20. The instructions may also be configured to charge 80 the supplier 14 an influence fee 60 based on the per-service price 54 and the at least one consumer influence metric 58. Having achieved the charging to the supplier 14 of the cost of the consumer influencing service in a quantifiable manner, the exemplary method 70 ends at 82.

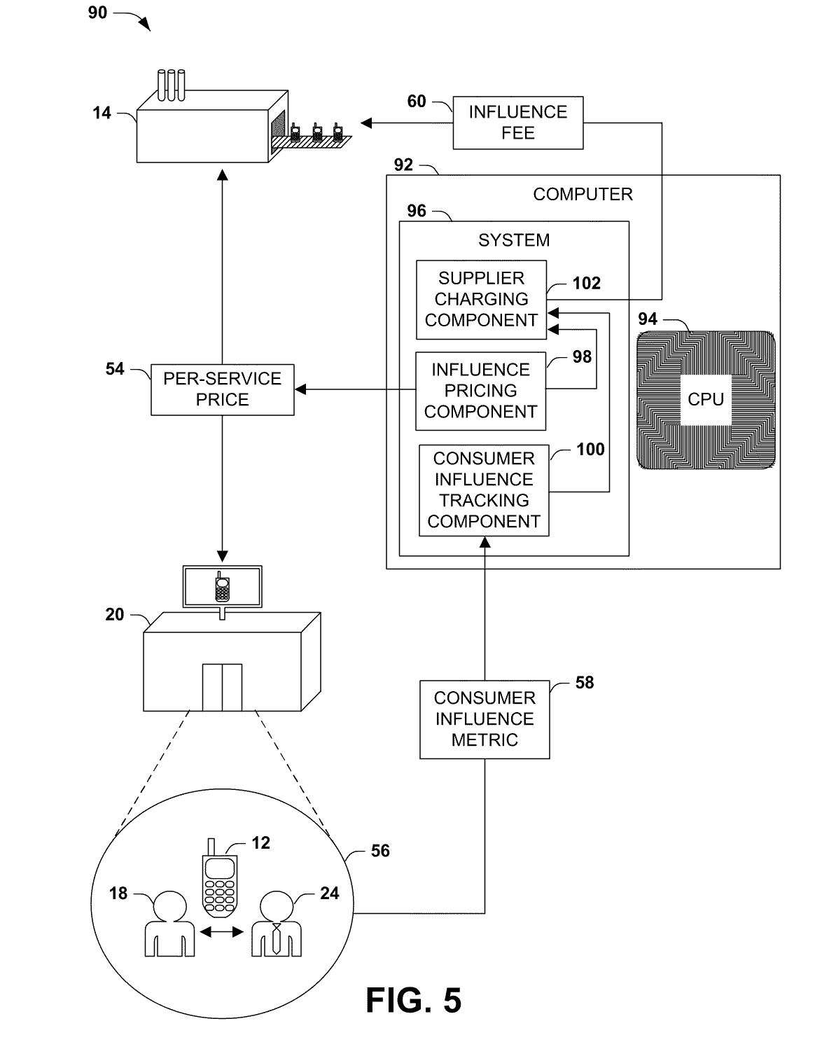

FIG. 5 illustrates an exemplary scenario 90 featuring a second embodiment of the techniques discussed herein, comprising an exemplary system 96 configured to compensate a consumer store 20 for influencing consumer choices regarding products 12 offered by at least one supplier 14. The exemplary system 96 may, e.g., be embodied as a software architecture comprising instructions executing on a processor 94 of a computer 92 expressed as a set of components configured to interoperate in the following manner. The exemplary system 96 may comprise an influence pricing component 98, which may be configured to establish a per-service price 54 for a consumer influencing service to be charged to the supplier 14. The exemplary system 96 may also comprise a consumer influence tracking component 100, which may be configured to track at least one consumer influence metric 58 for respective consumer influencing services provided to at least one consumer 18 regarding at least one product 12 offered by the consumer store 20 (e.g., an interaction 56 of a sales associate 24 with a consumer 18 regarding the product 12 of the supplier 14 offered by the consumer store 20.) The exemplary system 96 may also comprise a supplier charging component 102, which may be configured to charge the supplier 12 an influence fee 60 based on the per-service price 54 (established by the influence pricing component 98) and the at least one consumer influence metric 58 (tracked by the consumer influence tracking component 100.) The exemplary system 96 therefore enables the computer 92 to establish prices for the consumer influencing services offered by the consumer store 20, and to charge the supplier 14 according to the provided services based on a factual record of the provision of such services.

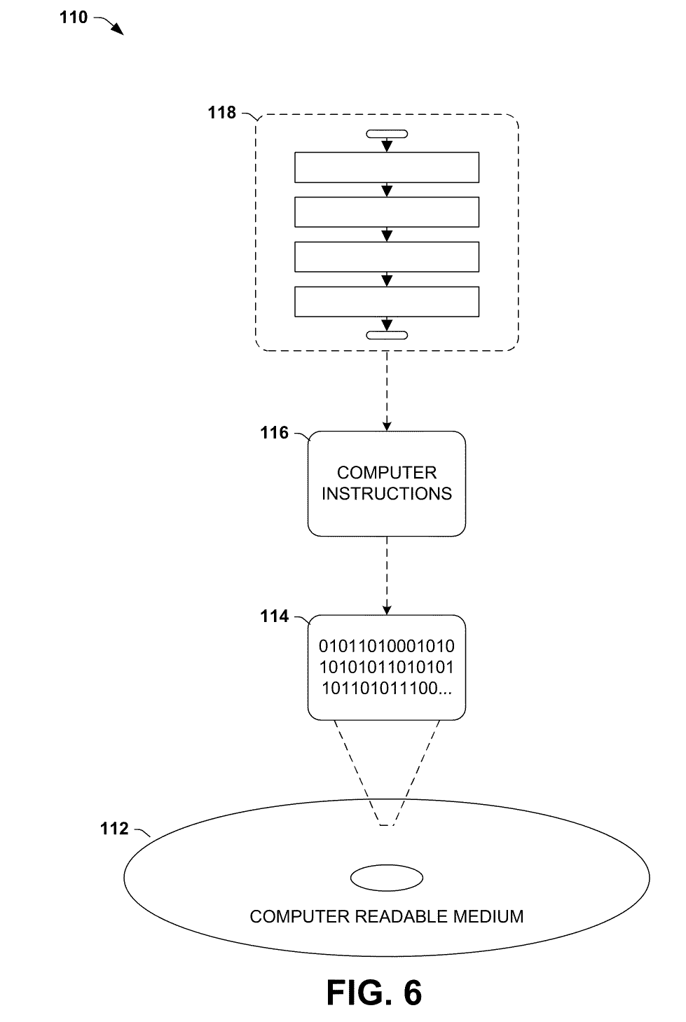

Still another embodiment involves a computer-readable medium comprising processor-executable instructions configured to apply the techniques presented herein. An exemplary computer-readable medium that may be devised in these ways is illustrated in FIG. 6, wherein the implementation 110 comprises a computer-readable medium 112 (e.g., a CD-R, DVD-R, or a platter of a hard disk drive), on which is encoded computer-readable data 114. This computer-readable data 114 in turn comprises a set of computer instructions 116 configured to operate according to the principles set forth herein. In one such embodiment, the processor-executable instructions 116 may be configured to perform a method of compensating a consumer store for consumer influencing services provided to consumers regarding at least one product of a supplier, such as the exemplary method 70 of FIG. 4. In another such embodiment, the processor-executable instructions 116 may be configured to implement a system for compensating a consumer store for consumer influencing services provided to consumers regarding at least one product of a supplier, such as the exemplary system 96 of FIG. 5. Many such computer-readable media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 4 of FIG. 4 and the exemplary system 96 of FIG. 5) to confer individual and/or synergistic advantages upon such embodiments.

A first aspect that may vary among embodiments of these techniques relates to the manner of establishing the per-service price 54 for the consumer influencing services. As a first variation, the consumer store 20 may establish a per-service price 54 for respective services (e.g., demonstrating a product 12 for a consumer 18, allowing a consumer 18 to inspect a product 12, and providing a recommendation of the product 12 as compared with other products in the same product category) that may be charged to any supplier 14 of a product 12 in the consumer store 20. As a second variation, the consumer store 20 may establish different per-service prices 54 for different suppliers 14. This example may be helpful, e.g., in permitting smaller suppliers 14 with smaller budgets, or the suppliers 14 of products 12 with smaller manufacturing margins (e.g., cheaper items or commodities), to afford the placement of products 12 in the store 20 based on lower per-service prices 54, while charging higher rates to well-established suppliers 14 or suppliers 14 of higher margin products 12 (e.g., expensive items, such as automobiles and home appliances.) As a third variation, the consumer store 20 may utilize an automated system, such as the influence pricing component 98 in the exemplary system 96 of FIG. 5, to establish per-service prices 54 for various suppliers 14 and/or consumer influencing services. For example, the influence pricing component 98 may establish per-service prices 54 by offering the consumer influencing services to a set of suppliers 14 in an auction model, where suppliers 14 may bid on the value of the per-service prices 54. Upon receiving at least one high bid for a consumer influencing service from at least one supplier 14, the influence pricing component 98 may establish the high bid as the per-service price for the consumer influencing service for the bidding supplier 14. This technique may allow suppliers 14 to compete for the value of the consumer influencing services offered by the consumer store 20, thereby promoting the funding of such services and possibly the improvement of such services (e.g., through better training of sales associates 24, who may be able to provide more knowledgeable information.) Those of ordinary skill in the art may devise many ways of establishing the per-service prices 14 of various consumer influencing services while implementing the techniques discussed herein.

A second aspect that may vary among embodiments of these techniques relates to the tracking, using a computer, of consumer influence metrics 58 representing the provision of consumer influencing services to a consumer. Because the consumer influencing value of the services provided by the consumer store 20 may be difficult to demonstrate qualitatively or in the aggregate, the consumer store 20 may only establish a trusted relationship with suppliers 12 regarding the overall value of the consumer influencing services by carefully tracking the provision of such services to consumers 18. This tracking may be more thoroughly achievable through the use of a computerized system that is configured to track the provision of such services to consumers 18.

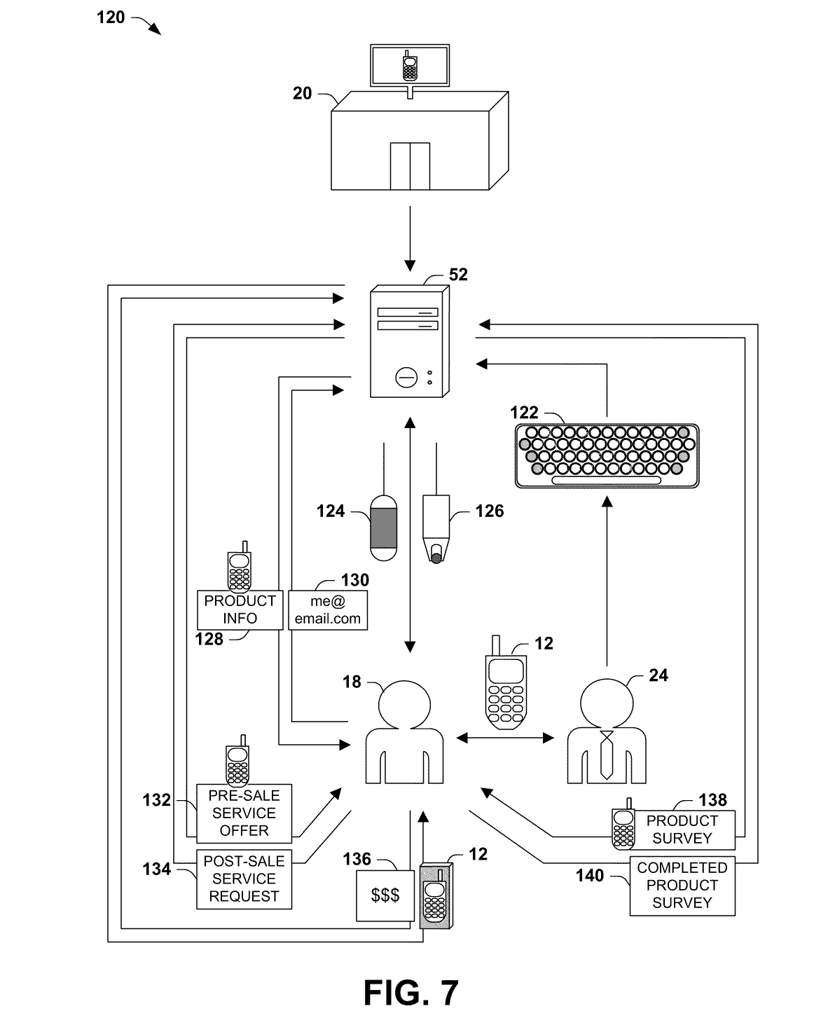

FIG. 7 illustrates a set of exemplary techniques for tracking, using a computer 52, the effect of a consumer influencing service on a consumer 18 in the purchase of a product 12. As a first variation, the consumer influencing service may be performed by an employee of the consumer store 20, such as a sales associate 24. The tracking may be performed by receiving from the employee a report of providing the consumer influencing service to the consumer 18 regarding the product 12 offered by the consumer store 20. For example, the sales associate 24 might simply detect interest by the consumer 18 in the product 12; might inform the consumer 18 about at least one feature of the product 12; might demonstrate the product 12 to the consumer 18; might instruct the consumer 18 in using the product 12; might compare the product 12 to other products 18 in the product category (either other products 18 offered by the consumer store 20, other products 18 offered by other retailers, or earlier or later models of such products 18); or might recommend the product 12 to the consumer 18. The sales associate 24 or other employee might then provide information about the interaction with the consumer 18, e.g., via a keyboard 122 or other input device, to the computer 52.

As a second variation illustrated in FIG. 7, the computer 52 might comprise at least one interaction capturing device, and might be configured to track the consumer influence metric 58 by capturing a recording of the consumer influencing service provided to the consumer 18. For example, the computer 52 might comprise an audio recording device 124 and/or a video recording device 126 that capture the consumer influencing service, e.g., an interaction of the consumer 18 with a sales associate 24 regarding the product 12, or a hands-on inspection of a product 12 by the consumer 18. More unobtrusive records of the consumer influencing service might be captured, e.g., by a detector included in the product 12 that detects and reports user interactions to the computer 52.

As a third variation illustrated in FIG. 7, the user 18 may request some information 128 about the product 12 from the consumer store 20, such as feature information, answers to consumer inquiries, or notifications of new versions of the product 12, price drops, or accessories. In exchange, the consumer 18 may provide an identifier, such as a name, the name of an affiliated company, or a username, and/or a contact identifier 130, such as a mailing address, an email address, or a telephone number, and the consumer store 20 may receive this contact identifier 130 and provide follow-up information 128 about the product 12. In this variation, the consumer influence metric 58 may comprise the identifier and/or the contact identifier 130 of the consumer 18, which may be provided as evidence of the visit of the consumer 12 to the consumer store 20, and/or the provision of the consumer influencing service of providing follow-up information offered by the consumer store 20.

As a fourth variation illustrated in FIG. 7, the consumer store 20 may offer to the consumer 18 at least one post-sale service for the product 12, such as an installation of the product 12, a diagnostic or troubleshooting service of the product 12, post-sale training in using the product 12, an in-store warranty repair of the product 12, shipping of the product 12 to the supplier 14 for a warranty repair, or a refund of a returned product 12 (to be returned to and recouped from the supplier 14.) The consumer store 20 may present to the consumer 18 a pre-sale service offer 132, and the consumer 18 may, after purchasing the product 12, accept the post-sale service 134 on the product 12 at the consumer store 20. The computer 52 may track the acceptance of the post-sale service 134 as the consumer influence metric 58. In this variation, it is noteworthy that, while consumer stores currently provide similar offers, such offers are usually conditioned on the consumer 18 purchasing the product 12 at the consumer store. In this variation, the incentive for the consumer store 20 is not necessarily in selling a unit of the product 12 at the consumer store 20, but rather in influencing the consumer 18 to purchase the product 12 anywhere, which is evidenced by the subsequent acceptance of the post-sale service 134. Therefore, the offer is not limited to a product 12 purchased by the consumer 18 at the consumer store 20, but rather on the provision of a consumer influencing service to the consumer 18 at the consumer store 20, such as a hands-on inspection of the product 12, a demonstration of the product 12, and/or a recommendation of the product 12 by a sales associate 24. The pre-sale service offer 132 may be coupled to these services, and the acceptance of the post-sale service 134 on the product 12 may be a reliable consumer influence metric 58, even if the sale is not completed at the consumer store 20. As an additional variation of this aspect, the post-sale service 134 may be offered specifically to the consumer 18, and specifically for the product 12 offered by the consumer store 20. For example, a per-service coupon may be issued to the consumer 18 upon providing the consumer influencing service with a coupon code that entitles only the consumer 18 to post-sale service 134 only for the product 12. This limitation may prevent forms of cheating, e.g., posting a coupon to the internet that anyone may use for the product 12, even consumers 18 who did not visit the consumer store 20 and did not receive the consumer influencing service.

As a fifth variation illustrated in FIG. 7, the consumer influence metric 58 may comprise a detected sale 136 of the product 12 to the consumer 18 at the consumer store 20. It may be appreciated that sales of a product 18 at the consumer store 20, which may be easily tracked and reported by the computer 52, may be partly indicative of the influence of the consumer store on the consumer 18 through the provision of consumer influencing services relating to the product 12. However, this correlation may be comparatively weak, because many consumers 18 may purchase the product 12 at the consumer store 20 without utilizing the consumer influencing services (e.g., the consumer 18 may have decided to purchase the product 12 before visiting the consumer store 20), and many other consumers 18 may purchase the product 12 at other retailers after having utilized the consumer influencing services. The strength of this correlation may be improved by associating the detected sale 136 of the product 12 to the consumer 18 with a pre-sale consumer influencing service that was provided to the consumer 18 regarding the product. For example, if the detected sale 136 follows a detected recommendation of the product 12 to the consumer 18 by the sales associate 24, or after an inspection of the product 12 by the consumer 18 at the consumer store 20. If these pre-sale consumer influencing services may be detected (e.g., by a record created by the sales associate 24 or by an audio or video input component), the influential value of the consumer influencing service may be more strongly demonstrated, and might even be charged to the supplier 14 at a higher per-service price 54. According to the techniques discussed herein, the influence fee 60 that is eventually assessed to the supplier 14 for this transaction is not based on the detected sale 136 of the product 12, but rather on the provision of the consumer influencing service to the consumer 18, the value of which is demonstrated by the subsequent sale 136.

As a sixth variation illustrated in FIG. 7, the consumer influence metric may be tracked by providing to the consumer 18 a consumer influence survey 130 after providing the consumer influence service to the consumer 18. The computer 52 may then receive a completed consumer influence survey 140 from the consumer 18 after the consumer 18 has purchased a product 12 within the product category (e.g., either one of the products 12 within the product category offered by the consumer store 20, either purchased at the consumer store 20 or at another retailer, or a product 12 within the product category that is not offered by the consumer store 20 but that is offered by other retailers.) Although the consumer influence survey 130 likely has little value as a consumer persuading service, the information contained therein may indicate the influential value of other consumer persuading services, such as product demonstrations and recommendations by sales associates 24. The completed consumer influence survey 140 may therefore comprise a consumer influence metric 58, and may serve as the basis for the influence fee 60 charged by the computer 52 to the supplier 14. Those of ordinary skill in the art may devise many ways of tracking consumer influence metrics 58 relating to various pre-sale consumer influencing services while implementing the techniques discussed herein.

A third aspect that may vary among embodiments of these techniques relates to the manner of charging suppliers 14 the influence fees 60 based on the established per-service prices 54. As a first example, since the tracking performed by the computer 52 is able to identify separate instances of the provision of consumer influencing services, respective suppliers 14 may simply be charged the product of the per-influence fee 60 for each consumer influencing service and the instances of each consumer influence service performed for a product 12 of the supplier 14. Other variations may take into account other factors. As a second example, if sales of products 12 at the consumer store 20 or at other retailers may be linked to the provision of a consumer influencing service by the consumer store 20, a higher per-influence fee 60 might be charged due to the proven efficacy of the service. As a third example, the influence fees 60 may be additionally adjusted according to the overall influence of the consumer store 20. It may be recognized that the consumer store 20 may influence a consumer 18 in ways other than the direct provision of a consumer influencing service to the consumer 18 regarding a particular product 12, such as by observing the provision of the service to another consumer 18 at the consumer store 20; by word-of-mouth information from another consumer 18 to whom the consumer influencing service was provided; and by simply identifying the selection of products 12 by the consumer store 20, where the consumer 18 has learned to trust such selections through a prior series of positive experiences from purchases of products 12 at the consumer store 20. In order to capture these and other attenuated effects of the consumer influence earned by the consumer store, the influence fee 60 may be adjusted by other factors, e.g., a reputation metric of the consumer store 20 among other retailers measured by consumer surveys, or by a consumer traffic metric that is measured by the computer 52 to identify the number of visitors on a particular day. Those of ordinary skill in the art may select and include many types of factors on which basis the influence fee 60 may be computed and charged while implementing the techniques discussed herein.

A fourth aspect that may vary among embodiments of these techniques relates to additional features that might be included in such embodiments. One significant feature is the selection of products by the consumer store 20, which may be performed in a manner that complements the influence-based focus discussed herein. Many retailers choose products 12 to be offered according to the estimated sales of such products in order to achieve high per-unit sales. However, if the focus of the consumer store 20 is providing consumer influencing services, products 12 may be selected for offering based on the influence value of offering such products 12 to consumers 18. As a first variation of this fourth aspect, products 12 may be selected that are likely to evoke a favorable consumer, such as products having a favorable consumer rating, a favorable consumer recommendation given to another consumer 18, or a favorable consumer purchase rate (e.g., fast-selling products.) By adjusting the set of offered products 12 toward popular and good products 12, the consumer store 20 may build a reputation for stocking only good products, and may therefore exert consumer influence simply by selecting a product 12 to be offered in the store. Additionally, this consumer influence may be charged back to the suppliers 14; i.e., if the product choices offered by the consumer store 20 demonstrably influence the purchasing choices of consumers 12 (because the consumer store 20 has earned a reputation for stocking good products 12), the consumer store may charge the supplier 14 for the consumer influencing service of offering the product 12 in the consumer store 20.

As a second variation of this fourth aspect, the consumer store 20 may choose to limit the products 12 offered within a particular product category to a small set of popular 12 or otherwise favorable products 12. For example, within the product category of digital cameras, the consumer store 20 may opt not for a large selection of products 12, which may include numerous cameras that evoke consumer dissatisfaction after purchase (e.g., by taking bad photos, by being difficult to use, or by being unreliable), that prompt a high rate of return to the store, and that reduce the influence of the consumer store 20. Instead, the consumer store 20 may endeavor to provide consumers 18 with a small range of options, such as the top five digital cameras on the market. This variation may be implemented, e.g., by establishing a product category limit that limits the products 12 within a product category that are offered by the consumer store 20 (e.g., establishing a limit of six digital cameras, or only the digital cameras that exceed a particular consumer satisfaction rating in a consumer product poll.) A product 12 within the product category may be added to the set of products 12 offered by the store only if the product category limit is satisfied.

Other variations of this technique may be achieved for additional improvements. As a first example, the set of products 12 within a particular product category may be limited to distinctive products 12, such as those having a particular model number or name brand that identifies the consumer store 20 as the source of the product 12. In this manner, the consumer store 20 may track and charge for its consumer influence based on the popularity of the distinctive models of the products 12. As a second example, the products 12 within a product category may be selected such that each product 12 is significantly differentiated by at least one product feature from the other products 12 in the product category, such as by price, capabilities, or compatibility with products 12 in other product categories (e.g., software that executes on particular computer platforms.) By limiting a product category to a restricted set of well-differentiated products 12, the consumer store 20 may improve the shopping experience of the consumer 18, who may make choices more easily among identifiably different products 12 within the product category.

As a third example, it may be advantageous to relate consumer satisfaction with the fees charged to a supplier 14, such that a supplier 14 may be charged less for products 12 that consumers 18 appreciate (e.g., products 12 that prompt a positive reaction from the consumer 18 during an interaction with the product 12 at the consumer store 20), and more for products 12 that consumers 18 do not appreciate. This adjustment may reflect the impact of the placement of the product 12 on the satisfaction of the consumers 18 in visiting the consumer store 20. This adjustment may also strongly incentivize suppliers 14 to provide products 12 that promote consumer satisfaction during such interactions. In such embodiments, the consumer satisfaction may be detected in various ways. For example, an embodiment of these techniques may be configured to detect an expression of a consumer 18 upon interacting with a product 12 (e.g., using a facial expression identification algorithm to analyze input from a camera; using a voice analyzer to analyze input from a microphone; or using a biorhythm sensor to identify various reactions, such as calmness, during an interaction of a consumer 18 with a product 12), and by identifying a consumer reaction of the consumer 18 to the product 12 based on the expression. The influence fee 42 charged to the supplier 14 of the product 12 may then be adjusted based on the consumer reaction to the product 12. Those of ordinary skill in the art may devise many techniques for choosing products 12 in a manner that improves the consumer influence of the consumer store 20, and that may be charged to suppliers 14, while implementing the techniques discussed herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

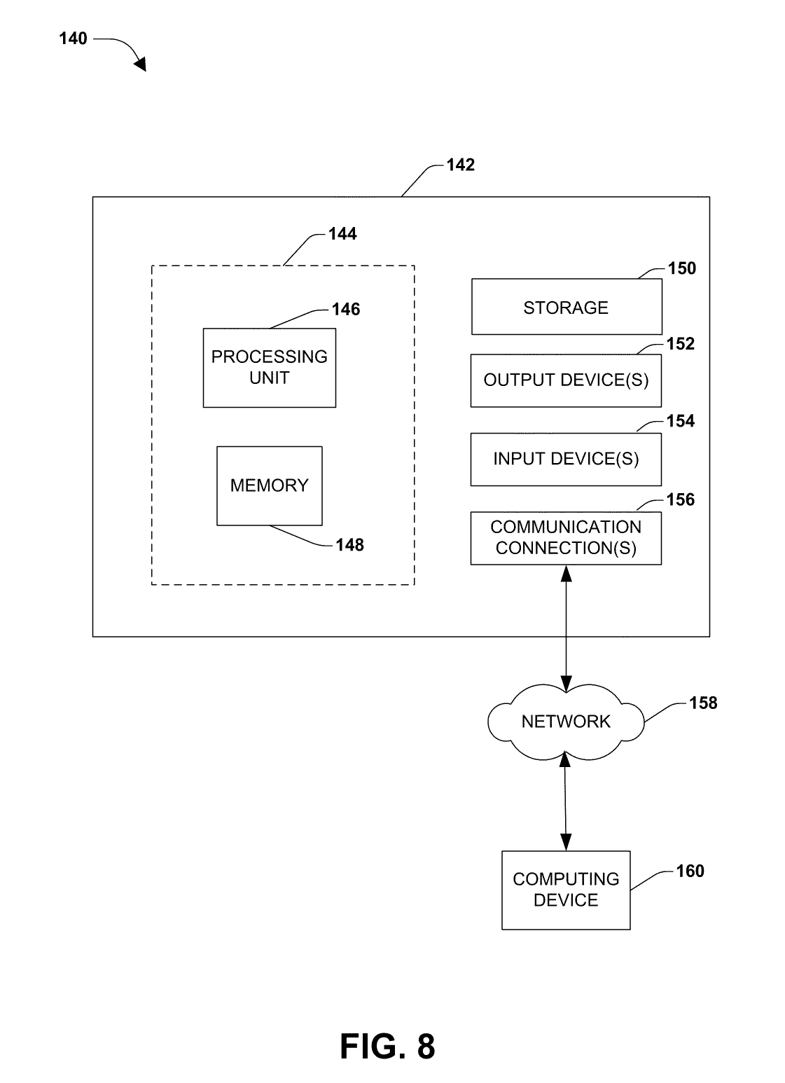

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 140 comprising a computing device 142 configured to implement one or more embodiments provided herein. In one configuration, computing device 142 includes at least one processing unit 146 and memory 148. Depending on the exact configuration and type of computing device, memory 148 may be volatile (such as RAM, for example), non-volatile (such as ROM, flash memory, etc., for example) or some combination of the two. This configuration is illustrated in FIG. 8 by dashed line 144.

In other embodiments, device 142 may include additional features and/or functionality. For example, device 142 may also include additional storage (e.g., removable and/or non-removable) including, but not limited to, magnetic storage, optical storage, and the like. Such additional storage is illustrated in FIG. 8 by storage 150. In one embodiment, computer readable instructions to implement one or more embodiments provided herein may be in storage 150. Storage 150 may also store other computer readable instructions to implement an operating system, an application program, and the like. Computer readable instructions may be loaded in memory 148 for execution by processing unit 146, for example.

The term “computer readable media” as used herein includes computer storage media. Computer storage media includes volatile and nonvolatile, removable and non-removable media implemented in any method or technology for storage of information such as computer readable instructions or other data. Memory 148 and storage 150 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 142. Any such computer storage media may be part of device 142.

Device 142 may also include communication connection(s) 156 that allows device 142 to communicate with other devices. Communication connection(s) 156 may include, but is not limited to, a modem, a Network Interface Card (NIC), an integrated network interface, a radio frequency transmitter/receiver, an infrared port, a USB connection, or other interfaces for connecting computing device 142 to other computing devices. Communication connection(s) 156 may include a wired connection or a wireless connection. Communication connection(s) 156 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 142 may include input device(s) 154 such as keyboard, mouse, pen, voice input device, touch input device, infrared cameras, video input devices, and/or any other input device. Output device(s) 152 such as one or more displays, speakers, printers, and/or any other output device may also be included in device 142. Input device(s) 154 and output device(s) 152 may be connected to device 142 via a wired connection, wireless connection, or any combination thereof. In one embodiment, an input device or an output device from another computing device may be used as input device(s) 154 or output device(s) 152 for computing device 142.

Components of computing device 142 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 142 may be interconnected by a network. For example, memory 148 may be comprised of multiple physical memory units located in different physical locations interconnected by a network.

Those skilled in the art will realize that storage devices utilized to store computer readable instructions may be distributed across a network. For example, a computing device 160 accessible via network 158 may store computer readable instructions to implement one or more embodiments provided herein. Computing device 142 may access computing device 160 and download a part or all of the computer readable instructions for execution. Alternatively, computing device 142 may download pieces of the computer readable instructions, as needed, or some instructions may be executed at computing device 142 and some at computing device 160.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method, using a computer having a processor, of compensating a consumer store for influencing consumer choices regarding products offered by at least one supplier, the method comprising:
establishing a per-service price for a consumer influencing service to be charged to the supplier, and
executing on the processor instructions configured to:
track at least one consumer influence metric for respective consumer influencing services provided to at least one consumer regarding at least one product offered by the consumer store, and
charge the supplier an influence fee based on the per-service price and the at least one consumer influence metric.

2. The method of claim 1, establishing the per-service price comprising:
offering respective consumer influencing services to a set of suppliers in an auction model, and
upon receiving at least one high bid for a consumer influencing service from at least one supplier, establishing the high bid as the per-service price for the consumer influencing services and for respective suppliers.

3. The method of claim 1:
the consumer influencing service performed by at least one employee of the consumer store, and
tracking the consumer influencing service comprising: receiving from the at least one employee a report of providing the consumer influencing service to the at least one consumer regarding at least one product offered by the consumer store.

4. The method of claim 3, the consumer influencing service selected from a set of consumer influencing services comprising:
detecting interest by a consumer in a product offered by the consumer store;
recommending a product to a consumer offered by the consumer store;
informing a consumer about at least one feature of a product offered by the consumer store;
demonstrating a product to a consumer offered by the consumer store;
instructing a consumer in using a product offered by the consumer store; and
comparing a product offered by the consumer store in a product category to at least one other product in the product category.

5. The method of claim 1:
the computer comprising at least one interaction capturing device, and
the consumer influence metric comprising a recording captured by the at least one interaction capturing device that illustrates the consumer influencing service provided to the at least one consumer

6. The method of claim 1:
the consumer influencing service comprising:
receiving from a consumer a request for information about a product offered by the consumer store and at least one contact identifier of the consumer, and
providing information about the product to the consumer using the at least one contact identifier; and
the consumer influence metric comprising the at least one contact identifier.

7. The method of claim 1:
the consumer influencing service comprising: offering to a consumer at least one post-sale service for a product offered by the consumer store before the consumer purchases the product, and
the consumer influence metric comprising: receiving from the consumer a request for post-sale service after the consumer purchases the product.

8. The method of claim 7, the at least one post-sale service offered specifically for the consumer and specifically for the product offered by the consumer store.

9. The method of claim 1, the consumer influence metric comprising: detecting a sale of the product to the consumer at the consumer store.

10. The method of claim 9, the instructions configured to associate the sale of the product to the consumer with a pre-sale consumer influencing service provided to the consumer regarding the product.

11. The method of claim 1, tracking the at least one consumer influence metric comprising:
providing a consumer influence survey to at least one consumer regarding at least one product offered by the consumer store within a product category after providing the consumer influence service to the consumer, and
receiving from the consumer a completed consumer influence survey after the consumer has purchased a product within the product category.

12. The method of claim 1:
the instructions configured to track a consumer traffic metric, and
charging the supplier comprising: charging the supplier an influence fee based on the per-service price, the at least one consumer influence metric, and the consumer traffic metric.

13. The method of claim 1, comprising:
establishing a product category limit that limits the products within a product category that are offered by the consumer store, and
adding a product within the product category offered by the consumer store within the product category limit.

14. The method of claim 13:
adding the product offered within the product category comprising: adding a distinctive product within the product category that is not available at other consumer stores; and
tracking the consumer influence metric comprising: tracking sales of the distinctive product.

15. The method of claim 13, adding the product offered within the product category comprising: adding a product within the product category that is significantly differentiated by at least one product feature from the other products within the product category.

16. The method of claim 13, adding the product offered within the product category comprising: adding a product within the product category having a favorable consumer response.

17. The method of claim 13, charging the supplier comprising: charging the supplier an influence fee based on the per-service price, the at least one consumer influence metric, and the products by the supplier added within the product category.

18. The method of claim 1:
the instructions configured to:
detect an expression of a consumer upon interacting with a product, and
identify a consumer reaction of the consumer to the product based on the expression; and
charging the supplier comprising: charging the supplier an influence fee based on the consumer reaction to the product.

19. A system configured to compensate a consumer store for influencing consumer choices regarding products offered by at least one supplier, the system comprising:
an influence pricing component configured to establish a per-service price for a consumer influencing service to be charged to the supplier;
a consumer influence tracking component configured to track at least one consumer influence metric for respective consumer influencing services provided to at least one consumer regarding at least one product offered by the consumer store; and
a supplier charging component configured to charge the supplier an influence fee based on the per-service price and the at least one consumer influence metric.

20. A computer-readable storage medium, the medium comprising instructions that, when executed on a processor of a computer, cause the processor to compensate a consumer store for influencing consumer choices regarding products offered by at least one supplier by:
establishing a per-service price for a consumer influencing service to be charged to the supplier by:
offering consumer influencing services to a set of suppliers in an auction model, and
upon receiving at least one high bid for a consumer influencing service from at least one supplier, establishing the high bid as the per-service price for respective consumer influencing services and respective suppliers;
tracking a consumer traffic metric;
establishing a product category limit that limits the products within a product category that are offered by the consumer store;
adding a product within the product category offered by the consumer store within the product category limit, the product being significantly differentiated by at least one product feature from the other products within the product category, and the product having a favorable consumer response selected from a set of favorable consumer responses comprising:
a favorable consumer rating;
a favorable consumer recommendation to another consumer; and
a favorable consumer purchase rate;
tracking at least one consumer influence metric for respective consumer influencing services performed by at least one employee of the consumer store for at least one consumer regarding at least one product offered by the consumer store, the consumer influencing service selected from a set of consumer influencing services comprising:
detecting interest by a consumer in a product offered by the consumer store;
recommending a product to a consumer offered by the consumer store;
informing a consumer about at least one feature of a product offered by the consumer store;
demonstrating a product to a consumer offered by the consumer store;
instructing a consumer in using a product offered by the consumer store; and
comparing a product offered by the consumer store in a product category to at least one other product in the product category; and the tracking comprising: receiving from the at least one employee a report of providing the consumer influencing service to the at least one consumer regarding at least one product offered by the consumer store; and
charging the supplier an influence fee based on the per-service price, the at least one consumer influence metric, and the consumer traffic metric.
